(19) United States
(12) Patent Application Publication
(10) Pub. No.: US 2024/0240862 A1
(43) Pub. Date: Jul. 18, 2024

(54) Mixed Flow Grain Dryer Including Conveyor

(71) Applicant: CTB, Inc., Milford, IN (US)

(72) Inventors: Mark S. DINGELDEIN, Milford, IN (US); Jeffrey E. WALKER, Fort Wayne, IN (US); Adam K. GUTWEIN, Goshen, IN (US); Grant KNOBLOCH, Milford, IN (US)

(21) Appl. No.: 18/412,953

(22) Filed: Jan. 15, 2024

Related U.S. Application Data
(60) Provisional application No. 63/439,544, filed on Jan. 17, 2023.

(51) Int. Cl. F26B 17/12; F26B 17/14; F26B 25/00

(52) U.S. Cl. CPC F26B 17/122; F26B 17/1458; F26B 25/002; F26B 2200/06

(57) ABSTRACT

A mixed flow grain dryer according to the present disclosure includes a plenum, a blower operable to force outside air into the plenum, a heater operable to heat air flowing from the blower to the plenum, at least one column, and a conveyor. The at least one column is configured to receive heated air from the plenum such that the heated air dries grain flowing through the at least one column. The at least one column is configured to change a flow direction of the heated air. The conveyor is configured to meter a discharge of grain from the at least one column.

### CROSS-REFERENCE TO RELATED APPLICATIONS

This application claims the benefit of U.S. Provisional Application No. 63/439,544, filed on Jan. 17, 2023. The entire disclosure of the application referenced above is incorporated herein by reference.

### FIELD

The present disclosure relates to mixed flow grain dryers including a conveyor.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Continuous flow grain dryers generally include a column of grain which flows by gravity between parallel walls. Heated air is forced through the column, thereby drying the grain. A metering system is generally incorporated in the lower portion of the grain dryer to control the discharge rate of grain exiting the dryer. Typically, it is desirable to dry grain to a preselected moisture content for storage or use. In order to attain a target moisture content for grain discharged from a grain dryer, the grain discharge rate should be accurately controlled.

Modular grain dryers can be supplied in varying lengths to accommodate various volumetric flow rates of grain, depending upon demand. A single discharge within a modular grain dryer requires that the grain discharge or metering rate be adjustable for the modular dryers in order to ensure a uniform moisture content of grain that is dried. Typically, grain dryers utilize funnels that direct grain from multiple columns to an auger, a metering roll within each funnel that meter the grain from the columns, and a system of conveyors that carry the metered grain from the auger to a discharge chute. The size of the funnels, the presence of the augers, and the system of conveyors increase the size (e.g., height and width) of the grain dryer for a given capacity, and the flow of grain through such grain dryers may be nonuniform, which may cause some grain to become overdried. In addition, rocks and other debris from the combine may clog the metering roll when unloading. Therefore, what is needed is a grain dryer with an adjustable discharge rate, smaller size for a given capacity, uniform grain flow therethrough, and a low likelihood of being clogged by debris from the combine.

### SUMMARY

An example of a mixed flow grain dryer according to the present disclosure includes a plenum, a blower operable to force outside air into the plenum, a heater operable to heat air flowing from the blower to the plenum, at least one column, and a conveyor. The at least one column is configured to receive heated air from the plenum such that the heated air dries grain flowing through the at least one column. The at least one column is configured to change a flow direction of the heated air. The conveyor is configured to meter a discharge of grain from the at least one column.

In one aspect, the at least one column is configured to change the flow direction of the heated air between a horizontal direction and a vertical direction.

In one aspect, each column of the at least one column includes a plurality of inlet ducts and a plurality of outlet ducts, each inlet duct of the plurality of inlet ducts has a horizontal inlet and a vertical outlet, and each outlet duct of the plurality of outlet ducts has a vertical inlet and a horizontal outlet.

In one aspect, the at least one column includes a pair of columns, and the plenum is disposed between the columns.

In one aspect, the mixed flow grain dryer further includes a shelf disposed below the plenum, and a trough disposed below the shelf. The shelf includes cutouts to allow grain to fall from the shelf to the trough. The conveyor is configured to meter grain from a discharge opening of the at least one column to the cutouts in the shelf.

In one aspect, the conveyor includes a paddle configured to push grain through the trough, a scooper assembly having a scooper panel configured to direct grain from the discharge opening to the cutouts, and a blocker assembly having a blocker panel configured to inhibit the flow of grain from the shelf to the trough.

In one aspect, the conveyor further includes a first sprocket, a second sprocket; and a chain engaged with the first and second sprockets and forming a loop. The first and second sprockets are disposed at opposite ends of the loop. The paddle, the scooper assembly, and the blocker assembly are coupled to the chain.

In one aspect, each column of the at least one column includes an inner wall, an outer wall, a discharge opening at least partially defined by the inner wall, and a grain flow diverter wall configured to direct grain from the inner wall to the outer wall.

In one aspect, the grain flow diverter wall is perforated.

In one aspect, each outer wall includes a vertical portion and an angled portion that is angled toward the inner wall, and the grain flow diverter wall is attached to the inner wall and extends downward and outward toward the angled portion of the outer wall.

Another example of a mixed flow grain dryer according to the present disclosure includes a plenum, a blower operable to force outside air into the plenum, a heater operable to heat air flowing from the blower to the plenum, a pair of columns a discharge chute, and a single conveyor. The columns are disposed on opposite sides of the plenum and configured to receive heated air from the plenum such that the heated air dries grain flowing through the columns. The conveyor is configured to carry grain from lower portions of the columns to the discharge chute.

In one aspect, the mixed flow grain dryer further includes a shelf disposed below the plenum, and a trough disposed below the shelf, the shelf including cutouts to allow grain to fall from the shelf to the trough. The conveyor is configured to meter grain from a discharge opening of each column to the cutouts in the shelf and to push grain through the trough to the discharge chute, which is disposed at an end of the trough.

In one aspect, the conveyor includes a first sprocket, a second sprocket, and a chain engaged with the first and second sprockets and forming a loop. The first and second sprockets are disposed at opposite ends of the loop.

In one aspect, the conveyor further includes a paddle coupled to the chain, a scooper assembly coupled to the chain, and a blocker assembly coupled to the chain. The paddle is configured to push grain through the trough as the chain moves along the loop. The scooper assembly has a scooper panel configured to direct grain from the discharge opening to the cutouts as the chain moves along the loop. The blocker assembly has a blocker panel configured to inhibit the flow of grain from the shelf to the trough as the chain moves along the loop.

In one aspect, the scooper panel is positioned at an acute angle relative to a direction of chain movement, and the blocker panel is positioned parallel to the chain movement direction.

Another example of a mixed flow grain dryer according to the present disclosure includes a plenum, a blower operable to force outside air into the plenum, a heater operable to heat air flowing from the blower to the plenum, and a pair of columns disposed on opposite sides of the plenum. The columns are configured to receive heated air from the plenum such that the heated air dries grain flowing through the columns. Each column is configured to change a flow direction of the heated air between a crosswise direction with respect to a flow direction of the grain and a counter direction with respect to the grain flow direction. The mixed flow grain dryer further includes a shelf disposed below the plenum, a trough disposed below the shelf, the shelf including cutouts to allow grain to fall from the shelf to the trough, and a conveyor configured to meter grain from a discharge opening of each column to the cutouts in the shelf. The conveyor includes a first sprocket, a second sprocket, and a chain engaged with the first and second sprockets and forming a loop extending along a length of the trough. The first and second sprockets are disposed at opposite ends of the loop. They conveyor further includes a plurality of paddles coupled to the chain and configured to push grain through the trough as the chain moves along the loop, a plurality of scooper assemblies coupled to the chain, and a plurality of blocker assemblies coupled to the chain. Each scooper assembly has a scooper panel configured to direct grain from the discharge opening to the cutouts as the chain moves along the loop. Each blocker assembly has a blocker panel configured to inhibit the flow of grain from the shelf to the trough as the chain moves along the loop.

In one aspect, each column of the pair of columns includes a plurality of inlet ducts and a plurality of outlet ducts, each inlet duct of the plurality of inlet ducts having an inlet extending perpendicular to the grain flow direction and an outlet extending parallel to the grain flow direction, and each outlet duct of the plurality of outlet ducts having an inlet extending parallel to the grain flow direction and an outlet extending perpendicular to the grain flow direction.

In one aspect, the mixed flow grain dryer further includes a plurality of carriers attached to the chain. The paddles are attached to a first side of one of the carriers, the scooper panels are attached to a second side of some of the carriers, and the blocker panels are attached to the second side of others of the carriers.

In one aspect, each column includes an inner wall, an outer wall, and a grain flow diverter wall configured to direct grain from the inner wall to the outer wall. A lower edge of the inner wall and the shelf define the discharge opening.

In one aspect, lower portions of the inner and outer walls form a hopper that directs grain from the columns to the conveyor, with the lower portions of the outer walls angled inward toward the plenum. The grain flow diverter walls are attached to the lower portions of the inner walls and extend downward and outward toward the lower portions of the outer walls.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an example of a mixed flow grain dryer according to the principles of the present disclosure;

FIG. 2 is a perspective view of the grain dryer of FIG. 1 with one of its columns removed to show a plenum between its columns;

FIG. 3 is a first side view of the grain dryer of FIG. 1;

FIG. 4 is a front view of the grain dryer of FIG. 1;

FIG. 5 is a second side view of the grain dryer of FIG. 1;

FIG. 6 is a perspective view of a portion of the grain dryer including a conveyor with the rest of the grain dryer shown in phantom to better illustrate the conveyor;

FIG. 7A is a perspective view of a portion of the conveyor of FIG. 6 with a cover of the conveyor removed to illustrate gearing inside the conveyor;

FIG. 7B is an enlarged perspective view of a portion of the conveyor of FIG. 6 within a circle A shown in FIG. 7A;

FIG. 8 is a section view of a portion of the grain dryer of FIG. 1 including lower portions of its columns, the plenum therebetween, and the conveyor;

FIG. 9 is a perspective view of a portion of the grain dryer of FIG. 1 including lower portions of its columns, the plenum therebetween, and the conveyor;

FIG. 10 is a sectioned perspective view of a portion of the grain dryer of FIG. 1 including its inlet and outlet ducts in one of its columns;

FIG. 11 is a section view of a portion of the grain dryer of FIG. 1 including the lower portions of its columns, the plenum therebetween, and the conveyor;

FIG. 12 is an enlarged section view of the portion of the grain dryer within a circle B of FIG. 11;

FIG. 13 is a sectioned perspective view of a portion of the grain dryer of FIG. 1 including lower portions of its columns, the plenum therebetween, and the conveyor;

FIG. 14 is an enlarged sectioned perspective view of the portion of the grain dryer within a circle C of FIG. 13;

FIG. 15 is a sectioned perspective view of a lower portion of one of the columns;

FIG. 16 is a sectioned perspective view of an alternative embodiment of a lower portion of one of the columns; and

FIG. 17 is a sectioned perspective view of the alternative embodiment of the lower portions of the columns with a block representing the conveyor therebetween.

In the drawings, reference numbers may be reused to identify similar and/or identical elements.

### DETAILED DESCRIPTION

A mixed flow grain dryer according to the present disclosure includes a pair of columns and a single conveyor that carries grain from the lower portions of the columns to a discharge chute. The conveyor includes features that are adjustable to control the discharge rate of grain from the grain dryer. The single conveyor may be used in place of the pair of augers and system of conveyors that are typically incorporated in a mixed flow grain dryer, which reduces the size of the grain dryer while providing an adjustable discharge rate and uniform unloading of grain from the columns. In addition, a mixed flow grain dryer according to the present disclosure has less mechanical components than a typical mixed flow dryer, and provides more flexibility for expanding the dryer line (e.g., adding more than two columns). Furthermore, the features that control the discharge rate of grain from the grain dryer are less likely to become clogged by debris from a combine compared to metering rolls.

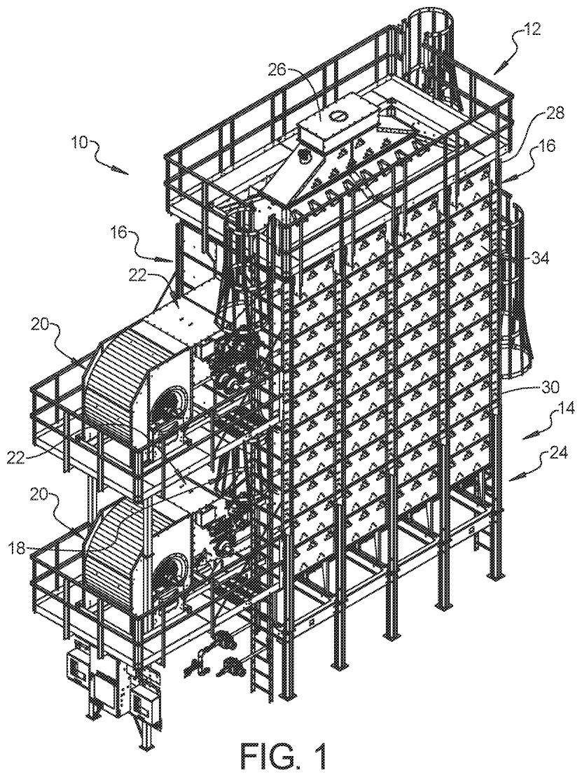

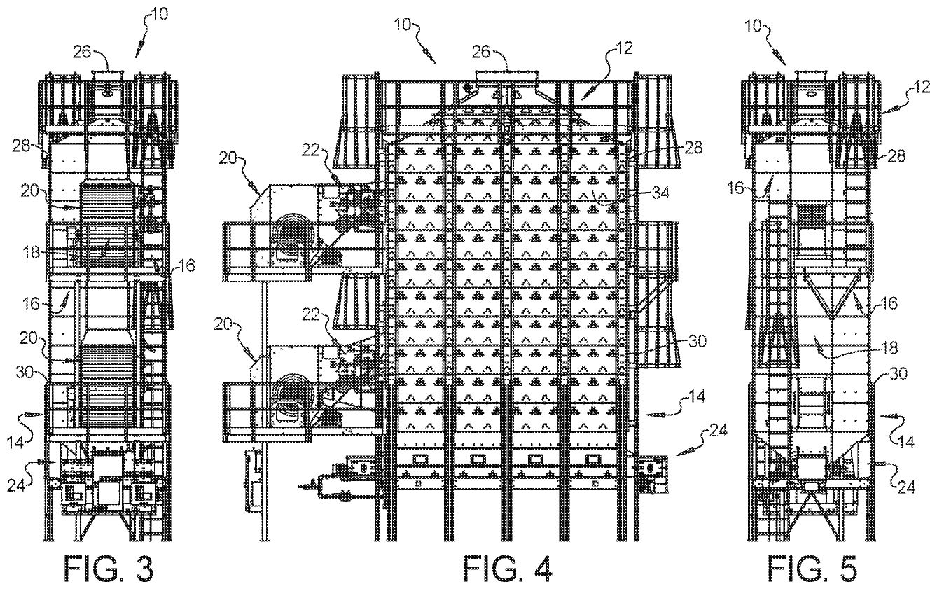

Referring now to FIGS. 1 through 5, a mixed flow grain dryer 10 according to the present disclosure includes a load section 12, an unload section 14, a pair of columns 16 extending vertically from the load section 12 to the unload section 14, a plenum 18 disposed horizontally between the columns 16, a pair of blowers 20 and a pair of heaters 22 positioned at one end of the plenum 18, and a conveyor 24 disposed below the plenum 18. The load section 12 has an inlet 26 configured to receive grain. The load section 12 funnels the grain to an upper end 28 of each column 16. The grain falls from the upper end 28 of each column 16 to a lower end 30 of each column 16.

The blowers 20 force outside air into the plenum 18, which diverts the air through the columns 16. Each heater 22 is positioned between one of the blowers 20 and the plenum 18 such that the heater 22 heats air flowing from the respective blower 20 to the plenum 18. As the heated air flows through the columns 16, the heated air dries the grain falling through the columns 16.

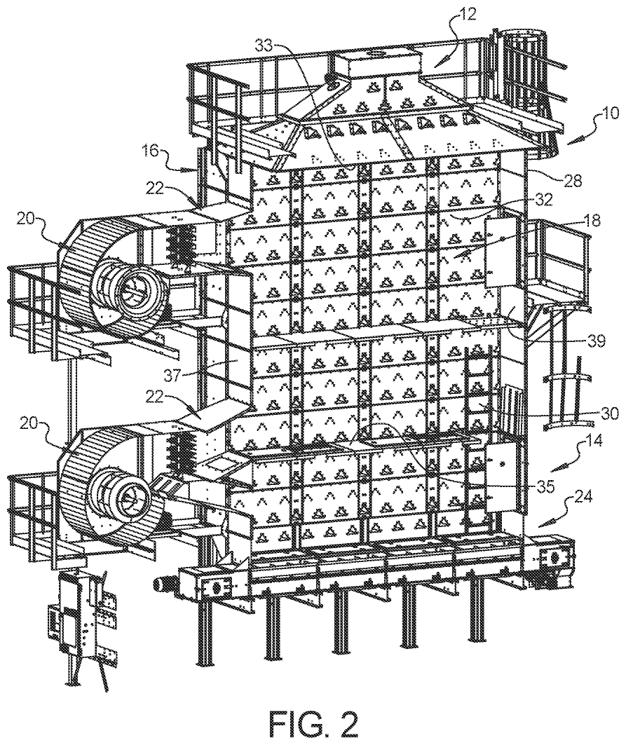

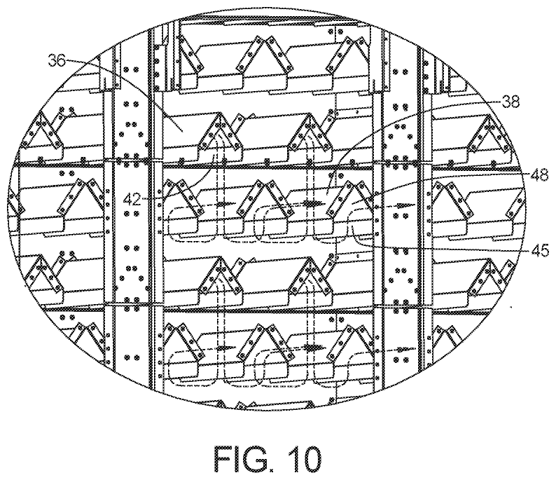

With additional reference to FIGS. 9-11 and 12, each column 16 includes an inner wall 32, an outer wall 34, a plurality of inlet ducts 36, and a plurality of outlet ducts 38. The inner walls 32 of the columns 16 form the outer walls of the plenum 18. As best shown in FIG. 2, the plenum 18 is also defined by an upper wall or ceiling 33, a lower wall or floor 35, a first end wall 37, and a second end wall 39. The ceiling 33 separates the plenum 18 from the load section 12. The floor 35 separates the plenum 18 from the unload portion 14. The plenum 18 may be hermetically sealed except for air pathways that allow air to flow into the plenum 18 and from the plenum 18 into the columns 16.

With continued reference to FIGS. 9-11, and 12, the inlet and outlet ducts 36 and 38 extend horizontally between the inner and outer walls 34. Each inlet duct 36 has an inlet 40 extending horizontally through one of the inner walls 32 (e.g., perpendicular to the flow of grain through the columns 16) and an outlet 42 extending vertically through a bottom side or surface 44 of the inlet duct 36 (e.g., parallel to the flow of grain through the columns 16). Each outlet duct 38 has an inlet 45 extending vertically through a bottom side or surface 46 of the outlet duct 38 (e.g., parallel to the flow of grain through the columns 16) and an outlet 48 extending horizontally through one of the outer walls 34 (e.g., perpendicular to the flow of grain through the columns 16). In the example shown, each of the inlet and outlet ducts 36 and 38 has a pentagonal cross section, and each of the inlets 40 and the outlets 48 has a triangular cross section. However, the inlet and outlet ducts 36 and 38, the inlets 40, and the outlets 48 may have other shapes.

Heated air from the plenum 18 flows horizontally through the inlets 40 of the inlet ducts 36 (i.e., crosswise with respect to the flow direction of grain through the columns 16) and flows downward into the columns 16 through the outlets 42 of the inlet ducts 36. The heated air then changes direction and rises vertically through the columns 16 (i.e., counter to the flow direction of grain through the columns 16). The rising heated air then enters the inlets 45 of the outlet ducts 38 and changes direction once again to flow horizontally into the atmosphere through the outlets 48 of the outlet ducts 38. Thus, the direction of airflow through the columns 16 is mixed, hence the reason that the grain dryer 10 is referred to as a mixed flow grain dryer.

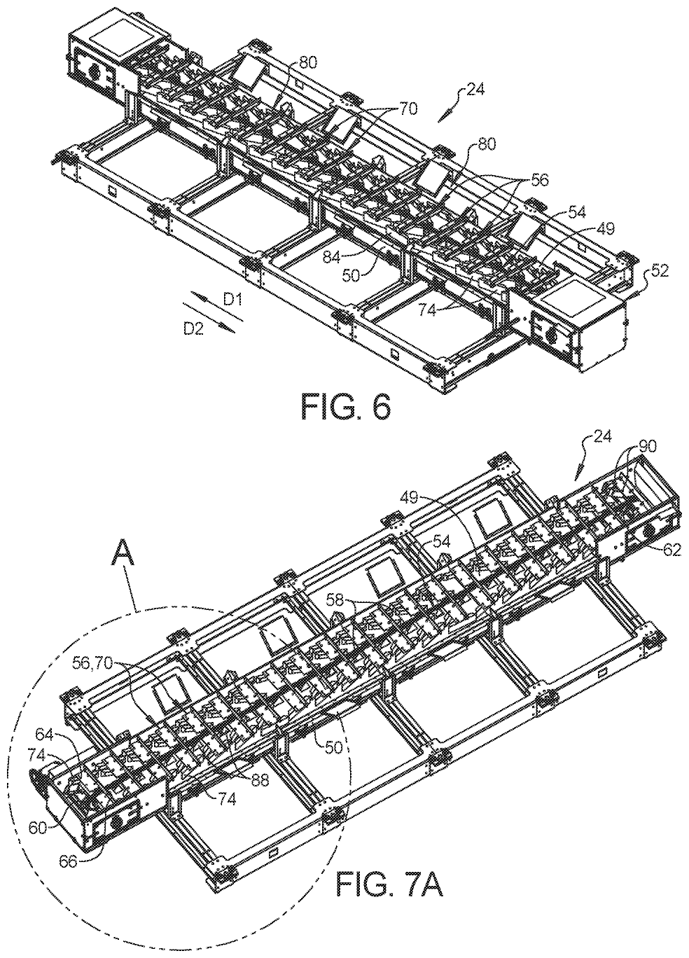

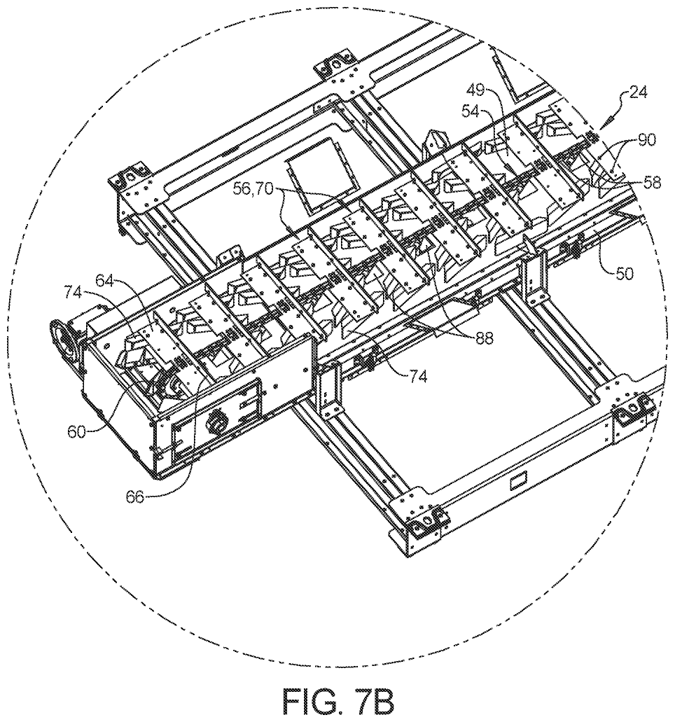

Referring now to FIGS. 6 through 8, the conveyor 24 includes a shelf 49, a trough 50 disposed below the shelf 49, a discharge chute 52 disposed at one end of the trough 50, a drive mechanism or chain 54 disposed above the shelf 49, and a plurality of base assemblies 56. As best shown in FIG. 7A, the chain 54 includes a plurality of links 58 engaging a first sprocket 60 and a second sprocket 62, which may be similar or identical to the first sprocket 60. The chain 54 is continuous and forms a loop, and the first and second sprockets 60 and 62 are disposed at opposite ends of the loop.

Each base assembly 56 includes a carrier 64, which is coupled to the chain 54, and a paddle 66. As best shown in FIG. 6, a scooper assembly 70 includes one of the base assemblies 56 and a scooper panel 74. A blocker assembly 80 includes one of the base assemblies 56 and a blocker panel 84. In the embodiment illustrated, the carrier 64 is constructed of 14-gauge galvanized steel, and the paddle 66, the scooper panel 74, and the blocker panel 84 are constructed of 3/16-inch ultra-high molecular weight (UHMW) polyethylene.

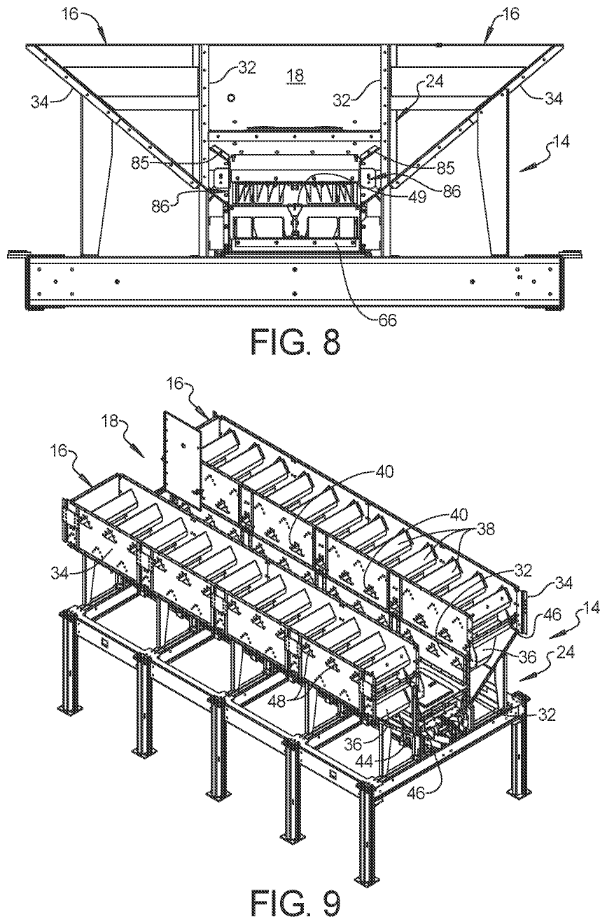

As best shown in FIG. 8, a lower edge 85 of each inner wall 32 and the shelf 49 define a discharge opening 86 extending along the length of each inner wall 32. As best shown in FIG. 7B, the shelf 49 includes cutouts 88 to allow grain to fall from the level of the shelf 49 to the trough 50. As discussed below, the scooper panels 74 direct grain from the discharge opening 86 to the cutouts 88.

The links 58 of the chain 54 cycle around the first and second sprockets 60 and 62. Because of the use of the continuous chain 54, the carrier 64 is carried in a first direction D1 (FIG. 6) and then in a second direction D2 which is generally opposite the first direction. At least a portion of the links 58 provide a locating position for the carriers 64 to attach thereto. One of the carriers 54 is attached to one of the links 58 about every foot along the length of the chain 54.

Each carrier 64 is configured to be a portion of either one of the scooper assemblies 70 or one of the blocker assemblies 80. Thus, the carriers 64 provide a selection of possible locating distances between the scooper panels 74 attached to different ones of the carriers 64. The carriers 64 that are not desired to act as scooper assemblies 70 are adapted to be blocker assemblies 80. In this manner, the conveyor 24 provides a metering conveyor system that will scoop a predetermined amount of grain from the shelf 49 that is generally proportional to the amount of selected scooper assemblies.

In operation, the blocker panels 84 prevent grain from moving from the discharge opening 86 to the cutouts 88. The scooper panels 74 peel a predetermined volume of grain from the discharge opening 86 and direct the grain to the cutouts 88. The volume of grain moved by one scooper panel 74 depends upon variables such as the linear speed of the conveyor 24, the height of grain on the shelf 49, and the width of grain that the scooper panel 74 removes from the shelf 49.

The linear speed of the conveyor 24 may be adjustable. The height of grain removed from the shelf 49 is determined by the height of the discharge opening 86 and the proximity of scooper panel 74 to the discharge opening 86. The width of grain removed from the shelf 49 by one scooper panel 74 is the width of the grain that is pushed toward cutouts 88 by the scooper panel 74. Preferably, the scooper panel 74 is positioned at an acute angle of attack relative to the direction of chain movement, and more preferably at an attack angle of less than about 45 degrees.

As best shown in FIGS. 7A and 7B, the conveyor 24 is configured such that the scooper panels 74 divert grain from the discharge opening 86 to the trough 50 as the carriers 64 cycle in the first direction D1, or away from the discharge chute 52. As best shown in FIG. 6, since the blocker panels 84 are oriented parallel to the direction of chain movement, the blocker panels 84 prevent grain from passing from the discharge opening 86 to the trough 50. In this manner, the blocker assemblies 80 inhibit the flow of grain from the shelf 49 to the trough 50.

As best shown in FIG. 8, the paddles 66 are configured to push grain through the trough 50 as the carriers 64 cycle in the second direction D2, or toward the discharge chute 52. As the carriers 64 rotate about the first sprocket 60, the paddles 66 push grain from the trough 50 into the discharge chute 52. In this manner, the conveyor 24 is configured to cycle in a fixed path, or continuous loop, and to direct the metered grain from the shelf 49, through the trough 50, and to the discharge chute 52.

When different sizes of dryers are provided (e.g., as a result of using more or fewer 2-foot grain dryer sections), the ratio of scooper assemblies to blocker assemblies may be changed to provide the varying desired volumetric flow rate. To accomplish this change, the scooper panels 74 or the blocker panels 84 are detached from the carriers 64, and the desired number of the scooper panels 74 or the blocker panels 84 are coupled to the carriers 64. As best shown in FIG. 7B, both the scooper panels 74 and the blocker panels 84 are removably attached to the carriers 64 with fasteners 90. Preferably, the fasteners 90 are stainless steel bolts having complementary nuts attached thereto.

Preferably, the carriers 64 are about one foot in length such that one of the carriers 54 is coupled to the chain 54 about every 12 inches. While FIG. 6 depict the conveyor 24 with an approximate ratio of one blocker assembly 80 to five scooper assemblies 70, it is envisioned that this ratio can be any range of ratios required to accommodate a preselected volumetric flow rate. As will be appreciated, the speed of the carriers 64 as they cycle through the conveyor 24 can be altered to achieve a different grain flow rate. It is envisioned that a more consistent discharge rate is accomplished when the scooper assemblies 70 are evenly distributed along the chain 54. Additional details regarding the conveyor 24 can be found in U.S. Pat. No. 6,834,442, which describes a similar conveyor incorporated in a cross flow grain dryer.

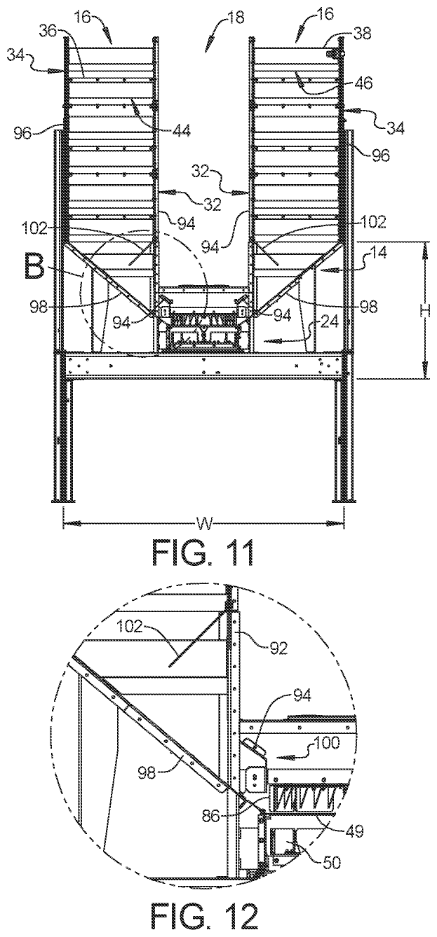

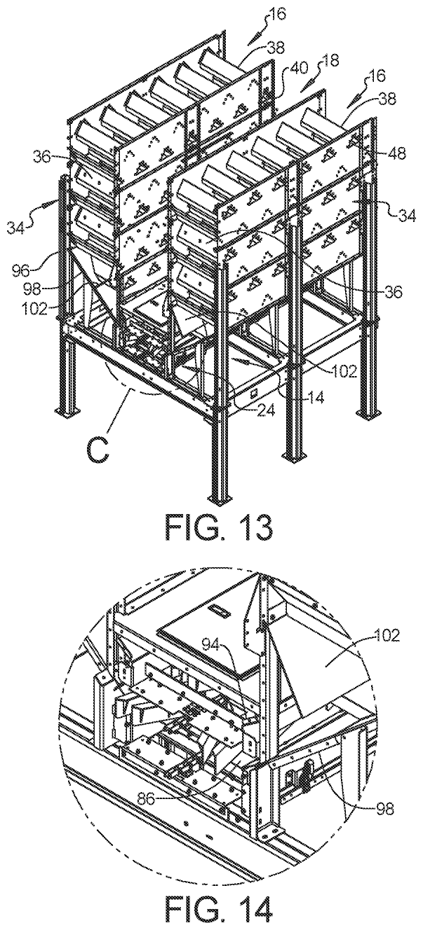

Referring now to FIGS. 11 through 14, in various implementations, each inner wall 32 includes a vertical portion 92 and an angled portion 94, and each outer wall 34 includes a vertical portion 96 and an angled portion 98. In the unload section 14, the angled portions 94, 98 of the inner and outer walls 32 and 34 form a hopper 100 that directs grain from the columns 16 to the conveyor 24. The arrangement of the unload section 14, with the hoppers 100 directing grain to the single conveyor 24, and the conveyor 24 pushing grain through the trough 50 to the discharge chute 52, reduces a height H of the unload section 14 and a width W of the grain dryer 10 relative to other mixed flow grain dryers of a similar capacity.

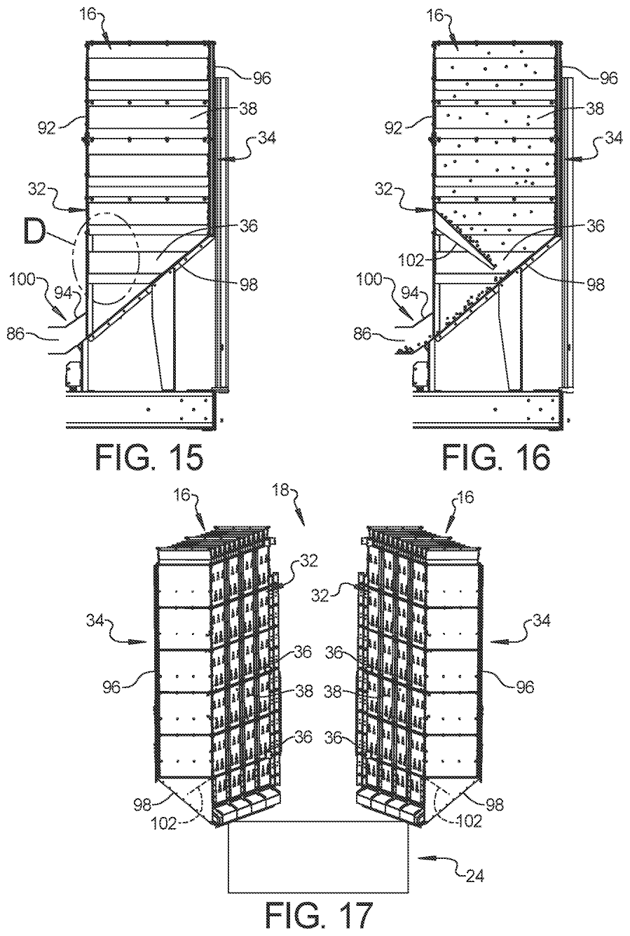

With additional reference to FIGS. 15 through 17, in various implementations, the grain dryer 10 further includes a grain flow diverter wall 102. As grain falls downward from the columns 16 into the hoppers 100, the grain tends to build up in an area D (FIG. 15) adjacent to the inner walls 32 when the grain dryer 10 does not include the grain flow diverter wall 102. In turn, the velocity of the grain flow adjacent to the inner walls 32 may be less than the velocity of the grain flow adjacent to the outer walls 34, which may cause grain adjacent to the inner walls 32 to become overdried. The grain flow diverter wall 102 directs grain from the inner walls 32 toward the angled portions 98 of the outer walls 34, which increases the evenness and uniformity of the grain flow through the hoppers 100 and thereby prevents overdying grain.

In various implementations, the entirety of each inner wall 32, each outer wall 34, and each grain flow diverter wall 102 may be solid, in which case the unload section 14 merely serves to direct grain to the conveyor 24 and does not allow airflow therethrough from the plenum 18 to the atmosphere. In other implementations, the vertical portions 92, 96 of the inner and outer walls 32 and 34 may be solid, and the angled portions 94, 98 of the inner and outer walls 32 and 34 may be perforated to allow air to pass therethrough from the plenum 18 to the atmosphere, in which case the unload section 14 mayperform similar to a cross flow dryer. Additionally, or alternatively, the grain flow diverter walls 102 may be perforated to allow air to pass therethrough.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A mixed flow grain dryer comprising:
a plenum;
a blower operable to force outside air into the plenum;
a heater operable to heat air flowing from the blower to the plenum;
at least one column configured to receive heated air from the plenum such that the heated air dries grain flowing through the at least one column, wherein the at least one column is configured to change a flow direction of the heated air; and
a conveyor configured to meter a discharge of grain from the at least one column.

2. The mixed flow grain dryer of claim 1 wherein the at least one column is configured to change the flow direction of the heated air between a horizontal direction and a vertical direction.

3. The mixed flow grain dryer of claim 1 wherein each column of the at least one column includes a plurality of inlet ducts and a plurality of outlet ducts, each inlet duct of the plurality of inlet ducts having a horizontal inlet and a vertical outlet, each outlet duct of the plurality of outlet ducts having a vertical inlet and a horizontal outlet.

4. The mixed flow grain dryer of claim 1 wherein the at least one column includes a pair of columns, and the plenum is disposed between the columns.

5. The mixed flow grain dryer of claim 4 further comprising:
a shelf disposed below the plenum; and
a trough disposed below the shelf, the shelf including cutouts to allow grain to fall from the shelf to the trough, wherein the conveyor is configured to meter grain from a discharge opening of the at least one column to the cutouts in the shelf.

6. The mixed flow grain dryer of claim 5 wherein the conveyor includes:
a paddle configured to push grain through the trough;
a scooper assembly having a scooper panel configured to direct grain from the discharge opening to the cutouts; and
a blocker assembly having a blocker panel configured to inhibit the flow of grain from the shelf to the trough.

7. The mixed flow grain dryer of claim 6 wherein the conveyor further includes:
a first sprocket;
a second sprocket; and
a chain engaged with the first and second sprockets and forming a loop, wherein the first and second sprockets are disposed at opposite ends of the loop, and the paddle, the scooper assembly, and the blocker assembly are coupled to the chain.

8. The mixed flow grain dryer of claim 1 wherein each column of the at least one column includes an inner wall, an outer wall, a discharge opening at least partially defined by the inner wall, and a grain flow diverter wall configured to direct grain from the inner wall to the outer wall.

9. The mixed flow grain dryer of claim 8 wherein the grain flow diverter wall is perforated.

10. The mixed flow grain dryer of claim 8 wherein each outer wall includes a vertical portion and an angled portion that is angled toward the inner wall, and the grain flow diverter wall is attached to the inner wall and extends downward and outward toward the angled portion of the outer wall.

11. A mixed flow grain dryer comprising:
a plenum;
a blower operable to force outside air into the plenum;
a heater operable to heat air flowing from the blower to the plenum;
a pair of columns disposed on opposite sides of the plenum and configured to receive heated air from the plenum such that the heated air dries grain flowing through the columns;
a discharge chute; and
a single conveyor configured to carry grain from lower portions of the columns to the discharge chute.

12. The mixed flow grain dryer of claim 11 further comprising:
a shelf disposed below the plenum; and
a trough disposed below the shelf, the shelf including cutouts to allow grain to fall from the shelf to the trough, wherein the conveyor is configured to meter grain from a discharge opening of each column to the cutouts in the shelf and to push grain through the trough to the discharge chute, which is disposed at an end of the trough.

13. The mixed flow grain dryer of claim 12 wherein the conveyor includes:
a first sprocket;
a second sprocket; and
a chain engaged with the first and second sprockets and forming a loop, wherein the first and second sprockets are disposed at opposite ends of the loop.

14. The mixed flow grain dryer of claim 13 wherein the conveyor further includes:
a paddle coupled to the chain and configured to push grain through the trough as the chain moves along the loop;
a scooper assembly coupled to the chain and having a scooper panel configured to direct grain from the discharge opening to the cutouts as the chain moves along the loop; and
a blocker assembly coupled to the chain and having a blocker panel configured to inhibit the flow of grain from the shelf to the trough as the chain moves along the loop.

15. The mixed flow grain dryer of claim 14 wherein the scooper panel is positioned at an acute angle relative to a direction of chain movement, and the blocker panel is positioned parallel to the chain movement direction.

16. A mixed flow grain dryer comprising:
a plenum;
a blower operable to force outside air into the plenum;
a heater operable to heat air flowing from the blower to the plenum;
a pair of columns disposed on opposite sides of the plenum and configured to receive heated air from the plenum such that the heated air dries grain flowing through the columns, wherein each column is configured to change a flow direction of the heated air between a crosswise direction with respect to a flow direction of the grain and a counter direction with respect to the grain flow direction;
a shelf disposed below the plenum;
a trough disposed below the shelf, the shelf including cutouts to allow grain to fall from the shelf to the trough; and
a conveyor configured to meter grain from a discharge opening of each column to the cutouts in the shelf, the conveyor including:
a first sprocket;
a second sprocket;
a chain engaged with the first and second sprockets and forming a loop extending along a length of the trough, wherein the first and second sprockets are disposed at opposite ends of the loop;
a plurality of paddles coupled to the chain and configured to push grain through the trough as the chain moves along the loop;
a plurality of scooper assemblies coupled to the chain, each scooper assembly having a scooper panel configured to direct grain from the discharge opening to the cutouts as the chain moves along the loop; and
a plurality of blocker assemblies coupled to the chain, each blocker assembly having a blocker panel configured to inhibit the flow of grain from the shelf to the trough as the chain moves along the loop.

17. The mixed flow grain dryer of claim 16 wherein each column of the pair of columns includes a plurality of inlet ducts and a plurality of outlet ducts, each inlet duct of the plurality of inlet ducts having an inlet extending perpendicular to the grain flow direction and an outlet extending parallel to the grain flow direction, each outlet duct of the plurality of outlet ducts having an inlet extending parallel to the grain flow direction and an outlet extending perpendicular to the grain flow direction.

18. The mixed flow grain dryer of claim 16 further comprising a plurality of carriers attached to the chain, wherein the paddles are attached to a first side of one of the carriers, the scooper panels are attached to a second side of some of the carriers, and the blocker panels are attached to the second side of others of the carriers.

19. The mixed flow grain dryer of claim 16 wherein each column includes an inner wall, an outer wall, and a grain flow diverter wall configured to direct grain from the inner wall to the outer wall, a lower edge of the inner wall and the shelf defining the discharge opening.

20. The mixed flow grain dryer of claim 19 wherein lower portions of the inner and outer walls form a hopper that directs grain from the columns to the conveyor, with the lower portions of the outer walls angled inward toward the plenum, and the grain flow diverter walls are attached to the lower portions of the inner walls and extend downward and outward toward the lower portions of the outer walls.
